(19) United States
(12) Patent Application Publication
(10) Pub. No.: US 2003/0053604 A1
(43) Pub. Date: Mar. 20, 2003

(54) Method for announcing data entering a communication terminal device and communication terminal device

(76) Inventors: Sven Berauer, Wolfratshausen (DE); Albert Bueckers, Matelen (DE)

Correspondence Address: Bell, Boyd & Lloyd LLC, P.O. Box 1135, Chicago, IL, 60690, US

(21) Appl. No.: 10/229,405

(22) Filed: Aug. 28, 2002

(30) Foreign Application Priority Data
Aug. 28, 2001 (DE) 101 42 013.7

(51) Int. Cl. H04M 1/64; H04Q 7/20

(52) U.S. Cl. 379/88.11; 379/67.1; 455/458

(57) ABSTRACT

Provided are a method for announcing data entering a communication terminal device, and a communication terminal device, wherein at least parts of the data, depending on the origin of the data, are transmitted to a second communication terminal device with the assistance of a service for transmitting short messages, whereby at least one second communication terminal device is determined, in the first communication terminal device, as the receiver of the data parts by a first bit of address information stored in the first communication terminal device.

### BACKGROUND OF THE INVENTION

Telecommunication systems are known which allow a caller to record a message when the desired conversation partner is not present or, respectively, which make it possible to leave a text message or a numeric message.

Generally, these are communication terminal devices referred to as answering machines, which have a cassette tape recorder, digital memory or the like as a recording medium, for example.

Given answering machine systems, the recording of a message generally is introduced in an absence mode or, respectively, when a condition prescribed by the user occurs such as the phone is not answered after multiple rings or the mobile radio telephone is turned off.

It is conventional that an announcement informs the caller to record a message after a specific tone, whereby the caller then leaves a message if voice messages are concerned, whereby, after a message has been recorded, the recording generally stops by termination of the connection.

Generally, after the recording, the presence of a message is immediately shown on the answering machine by the blinking of a light-emitting diode, so that the user of the communication terminal device, upon returning, is immediately informed of the existence of the messages and can listen to same.

It is disadvantageous hereby that the user does not know about the stored messages until the user returns. Therefore, the function of a remote inquiry is available at answering machine systems, whereby the user can access the stored messages via an arbitrary further telecommunication terminal device after a bit of identification information has been entered.

Given this solution, however, it is disadvantageous that the user is not informed about new messages until the user consults his/her communication terminal device. The danger is particularly great that time-critical inquiries are missed since too much time may pass until the inquiry.

Furthermore, the user cannot retrieve text messages sent to the communication terminal device since the remote inquiry generally is a voice connection.

An object of the present invention is to provide a method and a communication terminal device for announcing data entering a communication terminal device.

### SUMMARY OF THE INVENTION

Given the inventive method for announcing data entering a first communication terminal device, at least parts of the data, depending on the origin of the data, are transmitted to a second communication terminal device with the assistance of a service for transmitting short messages, whereby at least one second communication terminal device is determined, in the first communication terminal device, as the receiver of the data parts by a first bit of address information stored in the first communication terminal device.

On the basis of the inventive method, a user is automatically and immediately informed of the incoming data when the user is away from the first communication terminal device, whereby the user need deposit only one bit of address information, such as call number or IP address, of a second communication terminal device which the user carries with him/her or of which he/she knows that he/she will be near it.

The function of transmitting incoming data is not always desired, so that the user has the possibility to switch the function on or off by adjusting an absence mode.

If an answering machine function implemented in the first communication terminal device is activated in that the absence mode is adjusted, only the implementation of an adjustment possibility is necessary in order to initiate two functions.

Advantageously, the user is only informed by transmitting the data part when a message was actually recorded on the answering machine (i.e., when the answering machine function was utilized), so that resources for the transmission can be effectively used.

If the data part is sent upon receipt of a short message, whereby it contains at least the content of the short message, the user is also informed of incoming short messages, particularly of text messages, during his/her absence.

Advantageously, the data part contains a bit of address information, particularly the call number, which characterizes the origin of the incoming data, so that the user is able to contact the originator of the message.

The method can be simply implemented when the first communication terminal device operates as a stationary terminal device, such as a fixed network telephone, or as a base station functioning according to the DECT standard, in particular, and when the second communication terminal device is fashioned as a mobile terminal device, such as a radio receiver “pager,” “Personal Digital Assistant” PDA, wireless telephone or mobile radio terminal device, since these mobile terminal devices generally are carried by a person, so that a message regarding data received at the stationary terminal device essentially can be received at any arbitrary location, whereby these mobile terminal devices can also represent characters for call numbers or text messages, for example. Furthermore, the mobile terminal devices operate according to communication standards which provide services for transmitting short messages such as the “Short Message Service” SMS given mobile radio terminal devices operating according to the “Global System Mobile” GSM standard, for example.

In order to ensure that a user, during his/her absence, is only informed of calls whose origin can be determined, so that it is possible to call back, the data part contains a call number that determines the origin of the call and can be shown according to “Calling Line Identification Presentation” CLIP, in particular.

If the data part is transmitted in regular time intervals which can be adjusted, in particular, the data received in the time interval can be collected and transmitted together, so that the resources are effectively used and the user is disturbed fewer times, whereby a transmission only occurs when data was actually received between two transmission times.

If the service for transmitting short messages operates according to the “Short Message Service,” other contents also can be sent in addition to numeric contents, whereby this allows a smooth communication particularly with respect to terminal devices that operate according to the GSM standard. Moreover, the use of SMS in fixed networks is also contemplated, so that the data received via SMS need not be converted in a complicated manner but must only be forwarded.

When parameters, which are used for checking the data arriving at the first communication terminal device, can be adjusted for the absence mode and when a transmission occurs dependent on the result of the check, a user can set up a type of filter which assures that only specific data or only data of a specific origin are forwarded.

If it is additionally possible to select the first address information dependent on the result, it is possible to set up a filter which transmits the data, according to their origin or content, to different second communication terminal devices. For example, it is thus possible to deposit a first bit of address information of a number of persons when the first communication terminal device is used by a number of persons, so that incoming data are communicated to a specific person dependent on the origin.

On the basis of parameters, it is also possible to activate and adjust the absence mode for each person separately.

The inventive communication terminal device has a first selection device which is configured such that at least parts of the data, depending on the origin of the data, are transmitted to a second communication terminal device with the assistance of, a service for transmitting short messages, whereby a second selection device, which is configured such that the first bit of address information stored in the first communication terminal device is selected for determining the second communication terminal device as the receiver of the data parts.

The communication terminal device makes it possible to manage incoming data to the effect that a user is informed of incoming data and possibly of their content during his/her absence, whereby, for this purpose, the transmission of parts of the data is sent depending on whether an origin address is known, or which origin address is known.

Additional features and advantages of the present invention are described in, and will be apparent from, the following Detailed Description of the Invention and the Figures.

### BRIEF DESCRIPTION OF THE FIGURES

FIG. 1 shows a flow chart of the method of the present invention.

FIG. 2 shows an arrangement having the inventive communication terminal apparatus.

### DETAILED DESCRIPTION OF THE INVENTION

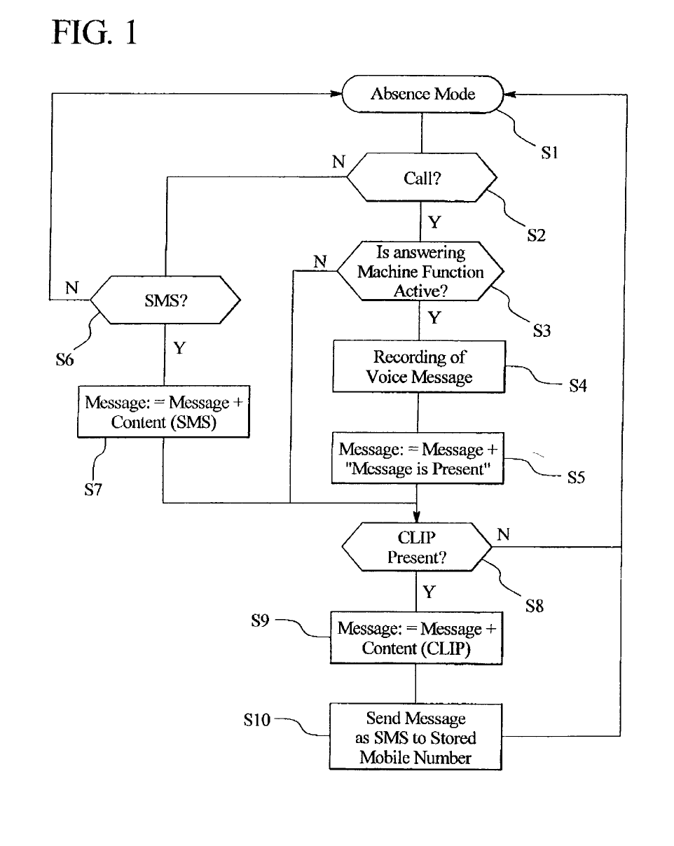

FIG. 1 shows a flow diagram representing an embodiment of the inventive method for announcing data entering a first communication terminal device.

The method is used when the communication device is in an absence mode or when other conditions adjusted by the user are fulfilled.

In a first step S1, a first communication terminal device is in an absence mode which has been adjusted by an owner of the communication terminal device.

For example, if the first communication terminal device is used by a number of persons, an absence arrangement, for each person individually, can be alternatively adjusted by setting corresponding parameters.

If a connection request arrives when the device is in this state, and if a connection occurs, a second step S2 initially checks whether it is a call.

If this is the case, a third step S3 checks whether a possibly present answering machine function is active, so that the caller, in a fourth step S4, offers and carries out the recording of a message.

After the recording, the content of the message to be transmitted to the absent user is composed via the input of data in a fifth step S5. For example, a short message having the text “message is present” is prepared for this purpose.

If it results from the check, in the second step S2, that a call is not present, a sixth step S6 checks whether an SMS has been transmitted via the present connection.

If this is the case, the content of the message to be transmitted to the absent user, in a seventh step S7, is composed via the input such that the content of the received SMS is accepted as a part of the message.

Subsequent to the fifth step S5 and seventh step S7, an eight step S8 checks whether the origin of the connection request can be determined by transmitting the call number according to the CLIP method, so that this origin, in a ninth step S9, as content with respect to the content accepted as a part of the message in the fifth step S5 and seventh step S7 or, respectively, if an SMS or voice message were not concerned but only a call, is accepted into the message as the only bit of information.

If a call number has not been transmitted by CLIP, the method proceeds from the ninth step S9 to the initial state in the first step S1 without transmitting a message since the presence of a bit of call number information, regardless of the type of data received during the connection, is the critical part of the message in this exemplary embodiment.

However, it is also possible that a transmission of a message, when a call number identification is not present, is only disregarded when it was only a call since it makes no sense to send a message, that the received data are a call, which is present without a call number identification since the user does not have an advantage thereof; i.e., there is no possibility of initiating a meaningful reaction.

In a tenth step S10, the message is transmitted, whereby the message, configured as an SMS, is transmitted to a GSM mobile part, for example.

It is also possible to transmit the message via a radio call service such as “City Call,” “Euromessage,” “Inmarsat-Paging” or “Ermes” (i.e., to a what is referred to as pager), whereby the message, for this purpose, is possibly structured according to another service for transmitting short messages.

The present invention is not limited to the described exemplary embodiment representing a simple implementation of the inventive method. Further embodiments are also possible. For example, it is possible to implement an exemplary embodiment of the inventive method in a first communication terminal device that is used by a number of persons, whereby an adjustment occurs for each person separately, so that each person can adjust an absence mode or, respectively, a condition as to when a message is to be transmitted. Since other mobile part call numbers generally are also allocated to the persons, one of a number of possible mobile part call numbers is selected as a target address, whereby the adjusted conditions are checked.

Furthermore, it is also possible to carry out a selection such that only the incoming data meeting specific, adjustable conditions lead to a message, so that the operating comfort is increased as a result of individual adjustment possibilities, whereby this selection is adapted by adjusting parameters so that a variable filter function is assured.

The present invention is not limited to one method either but rather includes a communication terminal device (not shown) which may implement the method, such as a first selection device for determining whether data parts are to be transmitted or a second selection device which selects the first address information that determines the terminal device, whereby the selection occurs such that the conditions of the user are fulfilled, for example. Moreover, the communication terminal device is intended to implement the various embodiments of the method of the present invention as well.

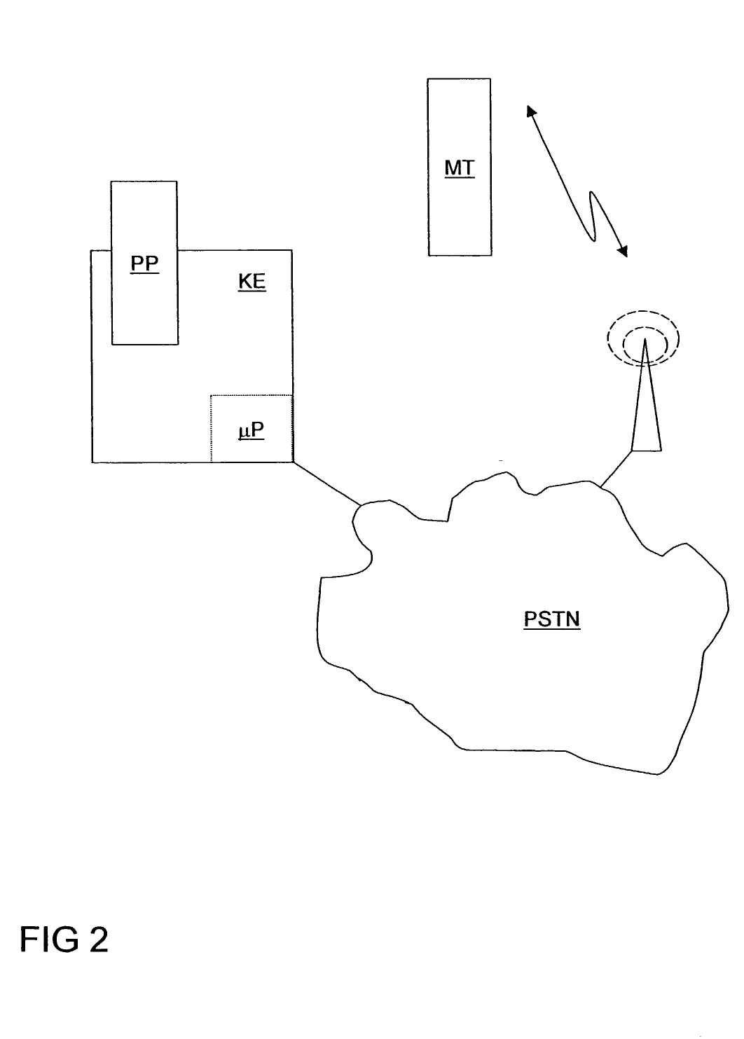

FIG. 2 shows an arrangement composed of the inventive communication terminal device KE, which is connected to a public telecommunication network (fixed network) PSTN, and of a mobile part MT.

Given the shown exemplary embodiment, the communication terminal device KE is a wireless base station which operates according to the “Digital European Cordless System” DECT standard and has a registered wireless mobile part PP which is deposited in the load shell of the base station KE, whereby the base station KE is configured such that it, via the fixed network, can transmit and receive messages configured according to the “Short Message Service” known from the “Global System Mobile” standard GSM.

It is also configured for evaluating call numbers transmitted as “Calling Line Identification Presentation” CLIP and has a call number memory which is configured such that a call number of a terminal device can be stored, whereby messages concerning received calls are to be transmitted to the terminal device.

Generally, a mobile second device of the user of the inventive communication terminal device is concerned.

As shown in the exemplary embodiment, the terminal device is the GSM mobile part MT. Alternatively, it can be a correspondingly configured “Personal Digital Assistant” PDA or a fixed network telephone which is able to receive SMS messages.

Given the shown inventive terminal device, a first selection part, which determines whether a call arrives that contains CLIP, and a second selection part, which selects the call number of the mobile part MT stored in the call number memory as destination for a message via the input of the call given receipt of such a call, are integrated into the microprocessor P of the communication terminal device.

Although the present invention has been described with reference to specific embodiments, those of skill in the art will recognize that changes may be made thereto without departing from the spirit and scope of the present invention as set forth in the hereafter appended claims.

1. A method for announcing data entering a first communication terminal device, the method comprising the steps of:
determining, in the first communication terminal device and by a first bit of address information stored in the first communication terminal device, at least one second communication terminal device as a receiver of at least part of the data; and
transmitting the data parts, depending on an origin of the data, to the second communication terminal device with assistance from a service for sending short messages.

2. A method for announcing data entering a first communication terminal device as claimed in claim 1, the method further comprising the step of enabling transmission to be switched by adjusting an absence mode.

3. A method for announcing data entering a first communication terminal device as claimed in claim 2, wherein an answering machine function implemented in the first communication terminal device is activated by adjusting the absence mode.

4. A method for announcing data entering a first communication terminal device as claimed in claim 3, wherein the data parts are transmitted via a caller when the answering machine function is used, with the data parts containing at least one bit of information with respect to use.

5. A method for announcing data entering a first communication terminal device as claimed in claim 1, wherein the data parts are transmitted given receipt of a short message, and the data parts contain at least a content of the short message.

6. A method for announcing data entering a first communication terminal device as claimed in claim 1, wherein the data parts contain a bit of address information which characterizes the origin of the data.

7. A method for announcing data entering a first communication terminal device as claimed in claim 1, wherein the first communication terminal device is a fixed network terminal device, and the second communication terminal device is one of a radio receiver pager, a personal digital assistant, a wireless telephone and a mobile radio terminal device.

8. A method for announcing data entering a first communication terminal device as claimed in claim 1, wherein the data parts contain a call number that determines the origin of the call and has been transmitted according to calling line identification presentation, and are transmitted given a call, with the data parts containing at least the call number as information.

9. A method for announcing data entering a first communication terminal device as claimed in claim 1, wherein the data parts are transmitted in regular time intervals which can be adjusted, with the data parts containing at least bits of information concerning all data received between two transmissions.

10. A method for announcing data entering a first communication terminal device as claimed in claim 1, wherein the service is a short message service.

11. A method for announcing data entering a first communication terminal device as claimed in claim 2, the method further comprising the steps of:
adjusting parameters for the absence mode;
checking the data received in the first communication terminal device based on the parameters; and
activating transmission depending on a result of the check.

12. A method for announcing data entering a first communication terminal device as claimed in claim 2, the method further comprising the steps of:
adjusting parameters for the absence mode;
checking the data received in the first communication terminal device based on the parameters; and
selecting a first bit of address information depending on a result of the check.

13. A communication terminal device for announcing data entering the communication terminal device, comprising:
a first selection device for enabling transmission of at least parts of the data, depending on an origin of the data, to a second communication terminal device with assistance from a service for sending short messages; and
a second selection device for selecting a first bit of address information stored in the communication terminal device for determining the second communication terminal device as a receiver of the data parts.
